(19) United States
(12) Patent Application Publication
(10) Pub. No.: US 2011/0200108 A1
(43) Pub. Date: Aug. 18, 2011

(54) CHROMINANCE HIGH PRECISION MOTION FILTERING FOR MOTION INTERPOLATION

(75) Inventors: Rajan L. Joshi, San Diego, CA (US); Peisong Chen, San Diego, CA (US); Marta Karczewicz, San Diego, CA (US)

(73) Assignee: QUALCOMM Incorporated, San Diego, CA (US)

(21) Appl. No.: 13/011,634

(22) Filed: Jan. 21, 2011

Related U.S. Application Data
(60) Provisional application No. 61/305,891, filed on Feb. 18, 2010.

(51) Int. Cl. H04N 7/26

(52) U.S. Cl. 375/240.16; 375/E07.123

(57) ABSTRACT

A video coding unit may be configured to encode or decode chrominance blocks of video data by reusing motion vectors for corresponding luminance blocks. A motion vector may have greater precision for chrominance blocks than luminance blocks, due to downsampling of chrominance blocks relative to corresponding luminance blocks. The video coding unit may interpolate values for a reference chrominance block by selecting interpolation filters based on the position of the pixel position pointed to by the motion vector. For example, a luminance motion vector may have one-quarter-pixel precision and a chrominance motion vector may have one-eighth-pixel precision. There may be interpolation filters associated with the quarter-pixel precisions. The video coding unit may use interpolation filters either corresponding to the pixel position or neighboring pixel positions to interpolate a value for the pixel position pointed to by the motion vector.

This application claims the benefit of U.S. Provisional Application No. 61/305,891, filed on Feb. 18, 2010, which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

### SUMMARY

In general, this disclosure describes techniques for coding of chrominance video data. Video data typically includes two types of data: luminance pixels that provide brightness information and chrominance pixels that provide color information. A motion estimation process may be performed with respect to luminance pixels to calculate a motion vector (a luminance motion vector), which may then be reused for chrominance pixels (a chrominance motion vector). There may be half as many chrominance pixels as luminance pixels due to sub-sampling in the chrominance domain. That is, each chrominance component may be downsampled by two in the row and column directions. Moreover, the luminance motion vector may have one-quarter-pixel precision, which may cause the chrominance motion vector to have one-eighth-pixel precision in order to reuse the luminance motion vector for the chrominance pixels. This disclosure provides techniques for interpolating values for fractional pixel positions, such as one-eighth-pixel positions, to encode and decode chrominance blocks. This disclosure also provides techniques for creating interpolation filters for interpolating values of fractional pixel positions.

In one example, a method includes determining a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision, selecting interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector, interpolating values for a reference block identified by the chrominance motion vector using the selected interpolation filters, and processing the chrominance block using the reference block.

In another example, an apparatus includes a video coding unit configured to determine a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision, select interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector, interpolate values for a reference block identified by the chrominance motion vector using the selected interpolation filters, and process the chrominance block using the reference block.

In another example, an apparatus includes means for determining a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision, means for selecting interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector, means for interpolating values for a reference block identified by the chrominance motion vector using the selected interpolation filters, and means for processing the chrominance block using the reference block.

In another example, a computer-readable medium, such as a computer-readable storage medium, contains, e.g., is encoded with, instructions that cause a programmable processor to determine a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision, select interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector, interpolate values for a reference block identified by the chrominance motion vector using the selected interpolation filters, and process the chrominance block using the reference block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for interpolating values for fractional pixel positions for a chrominance motion vector.

FIG. 2 is a block diagram illustrating an example of a video encoder that may implement techniques for selecting interpolation filters.

FIG. 3 is a block diagram illustrating an example of a video decoder, which decodes an encoded video sequence.

FIG. 4 is a conceptual diagram illustrating fractional pixel positions for a full pixel position.

FIGS. 5A-5C are conceptual diagrams illustrating pixel positions of a luminance block and corresponding fractional pixel positions of a chrominance block.

FIG. 6 is a flowchart illustrating an example method for interpolating values for fractional pixel positions to encode a chrominance block.

FIG. 7 is a flowchart illustrating an example method for interpolating values for fractional pixel positions to decode a chrominance block.

FIGS. 8 and 9 are flowcharts illustrating methods for selecting interpolation filters to be used to calculate component contributions for both horizontal and vertical components.

FIG. 10 is a flowchart illustrating an example method for creating, from an existing up-sampling filter, interpolation filters to be used in accordance with the techniques of this disclosure.

### DETAILED DESCRIPTION

In general, this disclosure describes techniques for coding of chrominance video data. Video data (e.g., macroblocks) may include two types of pixels: luminance pixels relating to brightness and chrominance pixels relating to color. There may be half as many chrominance pixel values as luminance pixel values for a block of data, e.g., a macroblock. A macroblock may include, for example, luminance data and chrominance data. A video encoder may perform motion estimation with respect to the luminance pixels of a macroblock to calculate a luminance motion vector. The video encoder may then use the luminance motion vector to produce a chrominance motion vector pointing to the same relative pixel in the macroblock. The luminance motion vector may have fractional pixel precision, e.g., one-quarter-pixel precision.

Pixels of a chrominance block may be downsampled relative to pixels of a luminance block in a macroblock. This downsampling may cause the chrominance motion vector to point to a fractional pixel position of greater precision than the precision of the luminance motion vector. That is, in order for a coding unit to reuse the luminance motion vector as the chrominance motion vector, the chrominance motion vector may need to have greater precision than the luminance motion vector. For example, if the luminance motion vector has one-quarter-pixel precision, the chrominance motion vector may have one-eighth-pixel precision. In some examples, the luminance motion vector may have one-eighth-pixel precision. Accordingly, the chrominance motion vector may have one-sixteenth-pixel precision. However, the chrominance motion vector may be truncated to one-eighth-pixel precision. Therefore, the chrominance motion vector may have precision that is greater than or equal to the precision of the luminance motion vector.

Some video encoders use bilinear interpolation to interpolate values for one-eighth-pixel positions of a reference chrominance block, that is, a chrominance block that a chrominance motion vector points to. While bilinear interpolation is fast, it has a poor frequency response, which can result in increased prediction error. In accordance with the techniques of this disclosure, a video encoder may be configured to select interpolation filters to use when interpolating values of fractional pixel positions pointed to by motion vectors, based on horizontal components and vertical components of the motion vectors.

A motion vector may have a horizontal component and a vertical component. This disclosure uses “MVₓ” to refer to the horizontal component and “MV_{y}” to refer to the vertical component, such that a motion vector is defined according to {MVₓ, MV_{y}}. The horizontal and vertical components of a motion vector may have a full portion and a fractional portion. The full portion of a component may refer to a full pixel position to which the motion vector corresponds, while the fractional portion may refer to a fractional position corresponding to the full pixel position. The fractional portion may correspond to a fraction N/M, where N<M. For example, if a component of a motion vector were 2⅜, the full portion of the component would be 2, while the fractional portion would be ⅜. When a motion vector component is negative, the full pixel position may be chosen to be the largest integer smaller than the motion vector component. Thus, as one example, if a component of a motion vector were −2⅜, the full portion of the component would be −3, while the fractional portion would be ⅝. Note that in this case, the fractional portion is different than the fraction contained in the motion vector component. In general, for chrominance vectors having one eighth precision, if the fraction contained in the motion vector were N/8, the fractional portion for that motion vector would be (8−N)/8, assuming that the motion vector is negative. Thus, the horizontal and vertical components may be expressed as mixed numbers having proper fractions. The fractions may be dyadic fractions, that is, fractions having a denominator that is a power of two.

This disclosure refers to the fractional portion of the horizontal component as “mₓ” and the fractional portion of the vertical component as “m_{y}.” This disclosure refers to the full portion of the horizontal component as “FPₓ” and the full portion of the vertical component as “FP_{y}.” Thus, the horizontal component MVₓ may be expressed as FPₓ+mₓ, and the vertical component MV_{y} may be expressed as FP_{y}+m_{y}.

The techniques of this disclosure include selecting interpolation filters to use to interpolate a value for a fractional pixel position based on the horizontal and vertical components mₓ and m_{y} of a motion vector referring to the fractional pixel position. The techniques also include defining a set of interpolation filters for a set of fractional positions of a luminance pixel, e.g., one-quarter pixel positions. The value for a fractional pixel position may be determined as the combination of contributions of values determined for the horizontal component and the vertical component. In other words, the interpolated value for a fractional pixel position—value(fractional_position(mₓ, m_{y}))—may be determined as the combination of the values determined for the set of fractional positions of the components.

If the fractional portion of a component is equal to the full pixel position, then the value for the fractional portion of the component may be determined to be equal to the value of the full pixel position. If the fractional portion of a component is equal to one of the set of fractional pixel positions of the luminance block, then the value for the fractional portion of the component may be determined by evaluating the filter defined for the fractional position. Otherwise, the value for the fractional portion of a component may be determined as the average of contributions from neighboring fractional pixel positions.

As an example, suppose that a luminance motion vector has one-quarter-pixel precision and that a chrominance motion vector corresponds to a chrominance block downsampled relative to the luminance block by a factor of two. Then the potential fractional pixel positions for a component of the luminance motion vector are 0, ¼, ½, and ¾. In this example, in accordance with the techniques of this disclosure, filters may be defined for the ¼, ½, and ¾ fractional positions. These filters may be referred to as F₁, F₂, and F₃, respectively. These filters may be described as corresponding to fractional positions that can be expressed by a motion vector having one-quarter-pixel precision, that is, the same precision as the luminance motion vector. In this example, the chrominance motion vector may additionally refer to fractional pixel positions ⅛, ⅜, ⅝, and ⅞. These fractional pixel positions can be referred to by a motion vector having one-eighth-pixel precision, but not a motion vector having one-quarter-pixel precision.

In this example, if a component of the chrominance motion vector has a fractional portion equal to zero, then the value for the component is equal to the full pixel position referred to by the full portion of the component. If a component of the chrominance motion vector has a fractional portion equal to ¼, ½, or ¾, then the value for the component is equal to the value produced by executing the respective one of F₁, F₂, or F₃. Otherwise, the value for the component may be an average of the neighboring fractional positions.

For example, if the fractional portion of the component is ⅛, then the value for the component is an average of the value for the full pixel position and the value produced by executing F₁. As another example, if the fractional portion of the component is ⅜, then the value for the component is an average of the value for produced by executing F₁ and the value produced by executing F₂. As yet another example, if the fractional portion of the component is ⅝, then the value for the component is an average of the value for produced by executing F₂ and the value produced by executing F₃. As still another example, if the fractional portion of the component is ⅞, then the value for the component is an average of the value for produced by executing F₃ and the value of the neighboring full pixel position, e.g., FPₙ₊₁. In this example, it is assumed that the fractional portion in the other direction is zero.

This process may be used for each pixel in a reference chrominance block. The calculated values for the fractional pixel positions of the reference chrominance block may further be used to calculate a residual value for a chrominance block being encoded using the chrominance motion vector. That is, the encoded chrominance block may correspond to a chrominance residual value calculated as the difference between the prediction block (corresponding to a block of a reference frame having values for fractional pixel positions calculated according to the process described above) and the chrominance block to be encoded.

A decoder may receive a luminance motion vector for a luminance block corresponding to the chrominance block, use the luminance motion vector to form a chrominance motion vector for the chrominance block, and then use the same interpolation process described above to interpolate values of fractional pixel positions for a reference frame. The decoder may then decode the chrominance block by adding the residual value for the chrominance block to the predicted block. The block may then be rendered by combining the chrominance and luminance blocks to produce luminance and chrominance data for pixels that are to be displayed.

The process described above includes defining interpolation filters for each of the set of fractional pixel positions of the luminance block from an existing upsampling filter. The techniques of this disclosure also provide example methods for defining such interpolation filters. One example method may be used to obtain interpolation filters from a single up-sampling filter. Consider a one dimensional signal x[n] that is to be up-sampled by a factor of 4. In this case, another signal y[n] may be created by inserting 3 zeros between every two samples of x[n]. This may lead to aliasing, which can be eliminated by low-pass filtering y[n] with a filter h[n] having a cut off frequency of π/4. Let the filter be linear phase, having (2M+1) taps centered around 0, where M may be configured by a user. Then, the filtered signal s[n] can be written as:

$$s [ n ] = {\sum }_{m = - M}^{M} h [ m ] y [ n + m ] .$$

In this example, the filtering operation is expressed as an inner product rather than a convolution operation. Since y[n] is nonzero only when n is divisible by 4 in this example, for each n, only certain subset of coefficients of h[n] are needed for calculation of s[n] for a specific n. The subset may be determined by the remainder resulting from dividing n by 4 (denoted by n %4, using the modulo operator “%”). As an example, consider that M=11, so that h[n] has 23 taps. Then when n is equal to 1 (and similarly when (n %4) is equal to 1),

s[1]=h[−9]y[−8]+h[−5]y[−4]+h[−1]y[0]+h[3]y[4]+h[7]y[8]+h[11]y[12],

or, using an equivalent expression replacing y[n] values with corresponding x[n] values:

s[1]=h[−9]x[−2]+h[−5]x[−1]+h[−1]x[0]+h[3]x[1]+h[7]x[2]+h[11]x[3].

Thus, {h[−9], h[−5], h[−1], h[3], h[7], h[11]} can be considered a 6-tap filter to obtain the interpolated value for ¼-pixel position. Again, it is emphasized that in this example, the filtering operation is represented as an inner product operation, instead of conventional convolution operation, otherwise the above filter would be time-reversed. In this expression, h[k] refers to the k^{th} coefficient of filter h, which has 2M+1 coefficients. Similarly, the filters that can be used for ½-pixel position and ¾-pixel position may be, respectively,

{h[−10], h[−6], h[−2], h[2], h[6], h[10]}, and

{h[−11], h[−7], h[−3], h[1], h[5], h[9]}.

This example method may be used for producing interpolation filters to interpolate values at one-quarter-pixel fractional positions. In general, for fractional pixel interpolation with accuracy of 1/N, similar technique may be applied by first designing a linear phase low-pass filter with a cut-off frequency of π/N and then finding different subsets of the filter corresponding to the value of n %N to generate filters for different fractional pixel positions m/N, 0<=m<N.

In some examples, the filters produced by the example method above may be further refined. For example, for each filter, one may ensure that the coefficients sum up to one. This may avoid introducing a DC bias for interpolated values. As another example, for the original low pass filter h[n], one may ensure that h[0]=1 and h[4n]=0, when n is not equal to 0. This may avoid affecting original samples of x[n] when filtering.

For implementation purposes, filter coefficients may be expressed as fractions where all the coefficients have a common denominator that is a power of 2. For example, the common denominator may be 32. When executing the filter, the filter coefficients may be multiplied by the common denominator (e.g., 32) and rounded off to the nearest integer. Further adjustment by ±1 may be made to ensure that the filter coefficients sum up to the common denominator, e.g., 32. If the filter coefficients (disregarding the common denominator) are chosen so that they sum up to a higher value, better interpolation may be achieved at the cost of increased bit-depth for intermediate filtering calculations. In one example implementation, filter coefficients that sum up to 32 were chosen so that for video sequence having input bit-depth of 8 bits, the chrominance interpolation could be performed with 16-bit precision.

In one example implementation, the following filter coefficients were used:

h₁={2, −5, 28, 9, −3, 1};

h₂={2, −6, 20, 20, −6, 2}; and

h₃={1, −3, 9, 28, −5, 2}.

For IPPP and Hierarchical B configurations, the use of these filters for chrominance component interpolation provided improvement (decrease) in bit-rates of 1.46% and 0.68%, respectively, for equivalent peak signal-to-noise ratios for test sequences used in JCT-VC standardization efforts.

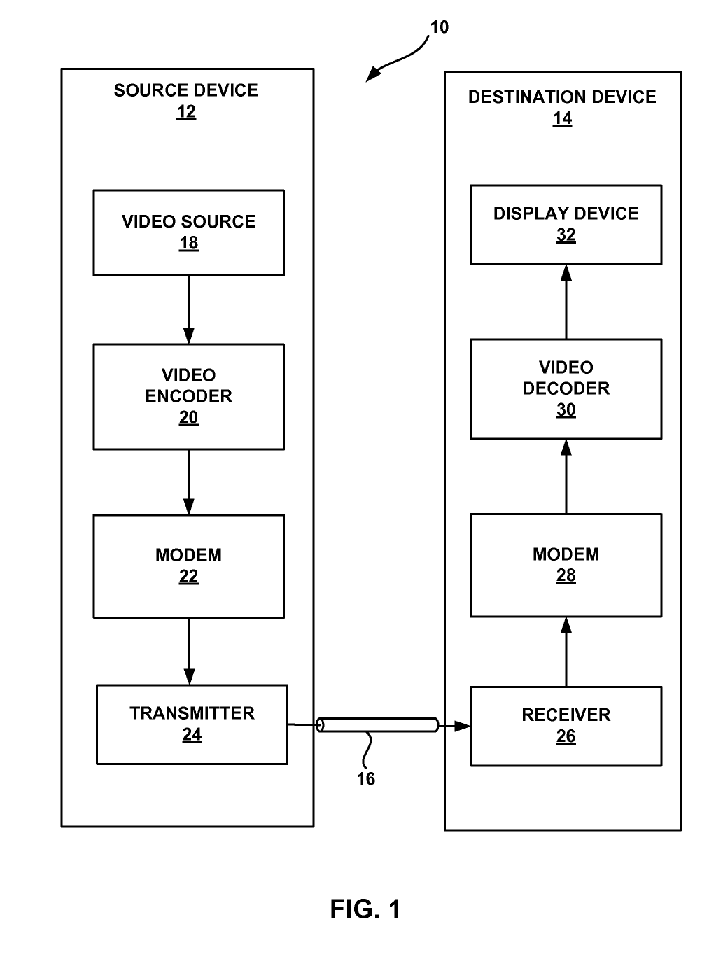

FIG. 1 is a block diagram illustrating an example video encoding and decoding system 10 that may utilize techniques for interpolating values for fractional pixel positions for a chrominance motion vector. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

The techniques of this disclosure, however, which concern interpolating values for fractional pixel positions for a chrominance motion vector, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 and video decoder 30 of destination device 14 may be configured to apply the techniques for selecting interpolation filters for interpolating values for fractional pixel positions, e.g., one-eighth-pixel positions, of reference frames to encode or decode chrominance blocks. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for selecting interpolation filters for interpolating values of fractional pixel positions of reference frames to encode or decode chrominance blocks may be performed by any digital video encoding and/or decoding device. Although generally the techniques of this disclosure are performed by a video encoding device, the techniques may also be performed by a video encoder/decoder, typically referred to as a “CODEC.” Video encoder 20 and video decoder 30 are examples of video coding units that may implement the techniques of this disclosure. Another example of a video coding unit that may implement these techniques is a video CODEC.

Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process may implement one or more of the techniques described herein to select interpolation filters for interpolating values of fractional pixel positions of reference frames to encode chrominance blocks. The information communicated over channel 16 may include syntax information defined by video encoder 20, which is also used by video decoder 30, that includes syntax elements that describe characteristics and/or processing of macroblocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. Although generally described with respect to 16×16 blocks, the techniques of this disclosure may apply to other sizes of blocks, e.g., 32×32, 64×64, 16×32, 32×16, 32×64, 64×32, or other block sizes. Accordingly, the techniques of this disclosure may be applied to macroblocks of sizes greater than 16×16.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” or “coding unit” may refer to any independently decodable unit of a video frame such as an entire frame, a slice of a frame, a group of pictures (GOP) also referred to as a sequence, or another independently decodable unit defined according to applicable coding techniques.

In accordance with the techniques of this disclosure, video encoder 20 may be configured to select interpolation filters for interpolating values of fractional pixel positions of reference frames to encode chrominance blocks. For example, while encoding a macroblock, video encoder 20 may first encode one or more luminance blocks of the macroblock using an inter-mode encoding process. This encoding process may result in one or more luminance motion vectors for the luminance blocks. Video encoder 20 may then calculate a chrominance motion vector for a chrominance block corresponding to a luminance block for one of the luminance motion vectors. That is, the chrominance block may be collocated with a luminance block of the same macroblock.

Video encoder 20 may be configured to perform motion search for the luminance block, and to reuse the luminance motion vector produced by the motion search for the chrominance block. The luminance motion vector generally points to a particular pixel within a reference block, e.g., the upper-left pixel of the reference block. Furthermore, the luminance motion vector may have fraction precision, e.g., one-quarter-pixel precision. There may be a 4:1 ratio of luminance pixels to chrominance pixels in the reference block. That is, there may be half as many pixels in each row and column in a chroma block relative to a collocated luminance block in a reference macroblock.

To reuse the luminance motion vector to encode the chrominance block, video encoder 20 may use an equal number of potential pixel positions (full or fractional) in the chrominance block as the luminance block. Therefore, the chrominance motion vector may have greater precision, in terms of the number of fractional pixel positions per pixel, than the luminance motion vector. This is a result of an equal number of pixel positions being divided among half as many pixels in the horizontal and vertical directions. For example, if the luminance motion vector has one-quarter-pixel precision, the chrominance motion vector may have one-eighth-pixel precision. In general, when the luminance vector has a precision of 1/N, the chrominance motion vector may have a precision of ½N. In some examples, the chrominance motion vector may be truncated to a precision of 1/N.

In the example of the luminance motion vector having one-quarter-pixel precision, video encoder 20 may be configured with three interpolation filters, each associated with one of the fractional one-quarter-pixel positions of a chrominance block (e.g., one-quarter, two-quarters, and three-quarters of a pixel). Video encoder 20 may first determine the location to which the chrominance motion vector points. The location may be defined by a horizontal component and a vertical component, each having full and fractional portions. Video encoder 20 may be configured to select interpolation filters based on the fractional portions of the horizontal and vertical components.

In general, video encoder 20 may calculate a value for the location to which the motion vector points based on a combination of a horizontal contribution and a vertical contribution, corresponding to the horizontal and vertical components. One of the components may first be calculated, and then the second component may be calculated using similarly situated pixels. For example, a horizontal component may first be calculated, and then pixels above and below having the same horizontal position may be used to calculate a value for the location pointed to by the motion vector. Values for the pixels above and below may first be interpolated.

If the motion vector points to the full pixel position, that is, both the horizontal and vertical components have zero-valued fractional portions, then video encoder 20 may simply use the value of the full pixel position as the value for the pixel pointed to by the motion vector. On the other hand, if either or both of the fractional portions of the horizontal and vertical components are non-zero, video encoder 20 may interpolate values for the location pointed to by the motion vector.

In the case where one of the two components has a non-zero-valued fractional portion, but the other component has a zero-valued fractional portion, video encoder 20 may only interpolate one value per pixel. In particular, video encoder 20 may use the value of the full pixel position as the contribution of the component having the zero-valued fractional portion. For example, if the horizontal component has a zero-valued fractional portion, and the vertical component has a fractional portion of one-quarter, video encoder 20 may interpolate a value for the vertical component, use the value of the full pixel position for the horizontal component, and combine these values to calculate the value for the location pointed to by the motion vector.

As noted above, video encoder 20 may be configured with interpolation filters for each of the one-quarter-pixel positions. In this example, let these filters be F₁, F₂, and F₃, where F₁ corresponds to the one-quarter position, F₂ corresponds to the two-quarters position, and F₃ corresponds to the three-quarters position. When a component points to a quarter-pixel position, video encoder 20 may calculate a value for the component using the filter corresponding to the fractional portion of the component. For example, if the vertical component has a fractional portion of one-quarter, video encoder 20 may calculate a vertical contribution using filter F₁.

When a component points to a one-eighth pixel position, video encoder 20 may calculate a value for the component using an average of values produced by neighboring filters or neighboring full pixel values. For example, if the horizontal component has a fractional portion of one-eighth (⅛), video encoder 20 may calculate the value for the horizontal component as the average of the full pixel position and the value produced by filter F₁. As another example, if the horizontal component has a fractional portion of three-eighths (⅜), video encoder 20 may calculate the value for the horizontal component as the average of the value produced by filter F₁ and the value produced by filter F₂.

In particular, let x correspond to the horizontal direction and y correspond to the vertical direction. Let (mₓ, m_{y}) denote the fractional pixel part of a motion vector having one-eighth-pixel precision. Thus, in this example: mₓ, m_{y} {0, ⅛, ¼, ⅜, ½, ⅝, ¾, ⅞}. Let the reference frame pixel corresponding to (mₓ, m_{y})=(0, 0) be denoted by P, and the prediction value be denoted by Q. Let filters F₁, F₂, and F₃ be associated with ¼, ½, and ¾ positions, respectively, for mₓ and m_{y}. Let E₈ refer to the set of one-eighth-pixel positions that have eight as a denominator such that the fractional representation cannot be further reduced. That is, let E₈={⅛, ⅜, ⅝, ⅞}. Let E₄ refer to the one-quarter pixel positions and above. That is, let E₄={0, ¼, ½, ¾}.

Video encoder 20 may first consider the case that neither mₓ nor m_{y} belong to E₈ (Step 1). In this case, video encoder 20 may interpolate a value for Q as follows. If (mₛ, m_{y})=(0, 0), Q=P (Step 1-1). Otherwise, if mₓ=0 (Step 1-2), video encoder 20 may calculate Q by applying the appropriate interpolation filter F₁, F₂, or F₃ for the value of the vertical component m_{y}. For example, if m_{y}=¼, video encoder 20 may use filter F₁. Similarly, if m_{y}=0 (Step 1-3), video encoder 20 may calculate Q by applying the appropriate interpolation filter F₁, F₂, or F₃ for the value of the horizontal component mₓ. For example, if mₓ=¾, video encoder 20 may use filter F₃. Finally, if both mₓ and m_{y} are non-zero (Step 1-4), video encoder 20 may apply one of F₁, F₂, or F₃ based on the value of m_{y} to generate an intermediate value corresponding to location (0, m_{y}), assuming that the full pixel location is (0, 0). Then depending on the value of mₓ, video encoder 20 may calculate a value for (mₓ, m_{y}) using one of F₁, F₂, or F₃ based on the value of mₓ. Video encoder 20 may first interpolate values for (n, m_{y}) as intermediate values to which the selected filter may refer. For example, for a six-tap filter, n={−2, −1, 0, 1, 2, 3} may be interpolated first, if they are not readily available. Video encoder 20 may be configured to to interpolate in the horizontal direction first and vertical direction next in some examples, instead of the interpolation order described above.

As another case, if either mₓ or m_{y} belongs to E₈ (Step 2), video encoder 20 may calculate the prediction value Q as follows. If mₓ E₈ and m_{y} E₄ (Step 2-1), video encoder 20 may first calculate an intermediate interpolation value Q₁ corresponding to location (0, m_{y}) using the appropriate one of F₁, F₂, or F₃. Video encoder 20 may then calculate the two values from E4 that are closest to mₓ. Let these values be denoted by mₓ₀ and mₓ₁. Video encoder 20 may calculate intermediate values Q₂ and Q₃, corresponding respectively to (mₓ₀, m_{y}) and (mₓ₁, m_{y}). If mₓ₀=0, Q₂ may be copied from Q₁. If mₓ₁=1, Q₂ may be copied from Q₁ of the next horizontal pixel. Video encoder 20 may calculate Q as the average of Q₂ and Q₃.

As an example, consider that the fractional part of the motion vector is (⅜, ¼). Then first, video encoder 20 may calculate Q₁ corresponding to (0, ¼) using filter F₁. Then, video encoder 20 may calculate Q₂ and Q₃, respectively corresponding to (¼, ¼) and (½, ¼), using filters F₁ and F₂, respectively. Finally, video encoder 20 may average these two values to find Q.

On the other hand, if mₓ E₄ and m_{y} E₈ (Step 2-2), video encoder 20 may first calculate a first intermediate interpolation value Q₁ corresponding to location (mₓ, 0) using the appropriate interpolation filter F₁, F₂, or F₃ in the horizontal direction, based on the value of mₓ or copied from P if mₓ is zero. Then, video encoder 20 may calculate the two values from E₄ that are closest to m_{y}. Let these values be denoted by m_{y0} and m_{y1}. Then, video encoder 20 may calculate interpolated values Q₂ and Q₃, corresponding to (mₓ, m_{y0}) and (mₓ, m_{y1}) using appropriate interpolation filters in the vertical direction. If m_{y0}=0, video encoder 20 may copy Q₂ from Q₁. Similarly, if m_{y1}=1, video encoder 20 may copy Q₃ from the Q₁ corresponding to the next vertical pixel. Then, video encoder 20 may calculate interpolation value Q for (mₓ, m_{y}) by averaging Q₂ and Q₃.

Finally, there is the case where mₓ E₈ and m_{y} E₈ (Step 2-3). In this case, video encoder 20 may calculate the two values (denoted mₓ₀ and mₓ₁) from E₄ that are closest to mₓ. Similarly, video encoder 20 may calculate the two values (denoted m_{y0} and m_{y1}) from E₄ that are closest to m_{y}. Then, for each of the four positions (mₓ₀, m_{y0}), (mₓ₀, m_{y1}), (mₓ₁, m_{y0}), (mₓ₁, m_{y1}), video encoder 20 may calculate intermediate values Q₁, Q₂, Q₃, and Q₄ in a manner similar to the case where neither mₓ nor m_{y} belong to E₈ (that is, similar to Step 1). Finally, video encoder 20 may average the intermediate interpolated values to calculate the interpolation value Q for (mₓ, m_{y}). In other examples, video encoder 20 may be configured to calculate only two intermediate values instead of four to find the final interpolated value Q. For example, video encoder 20 may be configured to calculate and average only intermediate values corresponding to diagonal positions (mₓ₀, m_{y0}) and (mₓ₁, m_{y1}) or (mₓ₀, m_{y1}) and (mₓ₁, m_{y0}) to obtain the final interpolated value for Q.

Those skilled in the art will recognize that when mₓ E₄ or m_{y} E_{8,} instead of using averaging to calculate the one-eighth pixel accuracy pixel position in the vertical direction from the two neighboring one-fourth pixel accuracy pixel positions, it may be possible to derive the position directly. Since filters F₁, F₂, and F₃ have the same lengths, adding the coefficients of two filters provides an equivalent one-eighth pixel position filter, up to a scaling factor. Thus if the chrominance motion vector points to a ⅜ pixel position, filter coefficients for F₁ and F₂ can be summed up position-by-position to derive the direct filter for the (0, ⅜) position. Thus, the filter corresponding to the ⅜ position is {4, −11, 48, 29, −9, 3}, in this example. It should be noted that the filter coefficients for this filter sum up to 64. Thus the right shift operation after filtering needs to be adjusted appropriately. The filter corresponding to full pixel position is assumed to be {0, 0, 32, 0, 0, 0}. Here we have assumed that F₁, F₂, and F₃ have 6 taps and they sum up to 32. Similarly, for the filter corresponding to the next full pixel position is {0, 0, 0, 32, 0, 0}.

Instead of deriving the one eighth pixel position filter from neighboring one quarter pixel position filters, it may be possible to design seven filters, one for each one-eighth pixel position, as described above.

The filtering techniques described in this disclosure may be performed in integer arithmetic. To do so, the steps described above may be modified for video encoder 20. As a notational convenience, subscript I is added to denote a result after integer arithmetic for the symbols and operations described previously. Symbols “<<” and “>>” refer to left-shift and right-shift operations, respectively. Also, it is assumed that the range of values for the original pixels is [0, 255] in this example. Integer arithmetic may be performed in 32-bit precision in this example. Intermediate interpolation values may be maintained at high precision until the very last step, where rounding, right-shifting, and clipping may be performed. Thus, the basic idea is that whenever filtering is applied, instead of immediately rounding, right-shifting and clipping, these operations may be delayed until after the averaging step, when multiple filtered pixels are averaged.

For Step 1-1, no change is necessary. For Step 1-2, video encoder 20 may calculate Q=(Q₁+16)>>5. For Step 1-3, video encoder 20 may calculate Q=(Q₁+16)>>5. For Step 1-4, video encoder 20 may calculate Q=(Q₁+512)>>10. For Step 2-1: if m_{y}=0, video encoder 20 may calculate Q_{1I}=P<<5; if mₓ₀=0, Q_{2I}=(Q_{2I}<<5); if mₓ₁=0, Q_{3I}=(Q_{3I}<<5). Also, for Step 2-1, video encoder 20 may ultimately calculate Q as the minimum of 255 and the maximum of (0, (Q_{2I}+Q_{3I}+1024)>>11). For Step 2-2: if mₓ=0, video encoder 20 may calculate Q_{1I}=P<<5; if m_{y0}=0, Q_{2I}=(Q_{2I}<<5); if m_{y1}=0, Q_{3I}=(Q_{3I}<<5). Also, for Step 2-2, video encoder 20 may ultimately calculate Q as the minimum of 255 and the maximum of (0, (Q_{2I}+Q_{3I}+1024)>>11).

For Step 2-3, Q_{1I}, Q_{2I}, Q_{3I}, and Q_{4I} respectively correspond to (mₓ₀, m_{y0}) and (mₓ₁, m_{y1}) or (mₓ₀, m_{y1}) and (mₓ₁, m_{y0})_{.} These values may be calculated in a manner similar to Step 1, except that the final rounding, right-shifting, and clipping steps need not be applied. Then, for values calculated using Step 1-1, the intermediate interpolated value may be left-shifted by 10. For values calculated using Steps 1-2 and 1-3, the intermediate interpolated values may be left-shifted by 5. Finally, video encoder 20 may calculate Q as the minimum of 255 and the maximum of (0, (Q_{1I}+Q_{2I}+Q_{3I}+Q_{4I}+2048)>>12).

After calculating values for each reference pixel of a reference chrominance block, video encoder 20 may calculate a residual for the chrominance block to be encoded. For example, video encoder 20 may calculate a difference value between the chrominance block to be encoded and the interpolated reference block. Video encoder 20 may use various difference calculation techniques, such as, for example, sum of absolute difference (SAD), sum of squared difference (SSD), mean absolute difference (MAD), mean squared difference (MSD), or others.

Following intra-predictive or inter-predictive coding to produce predictive data and residual data, and following any transforms (such as the 4×4 or 8×8 integer transform used in H.264/AVC or a discrete cosine transform DCT) to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, macroblock type, coding mode, maximum macroblock size for a coded unit (such as a frame, slice, macroblock, or sequence), or the like.

Video decoder 30 may be configured to interpolate values for one-eighth-pixel precision chrominance motion vectors in a manner similar to video encoder 20. After interpolating values of a reference chrominance block, video decoder 30 may add a received residual value to the reference chrominance block to decode a chrominance

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

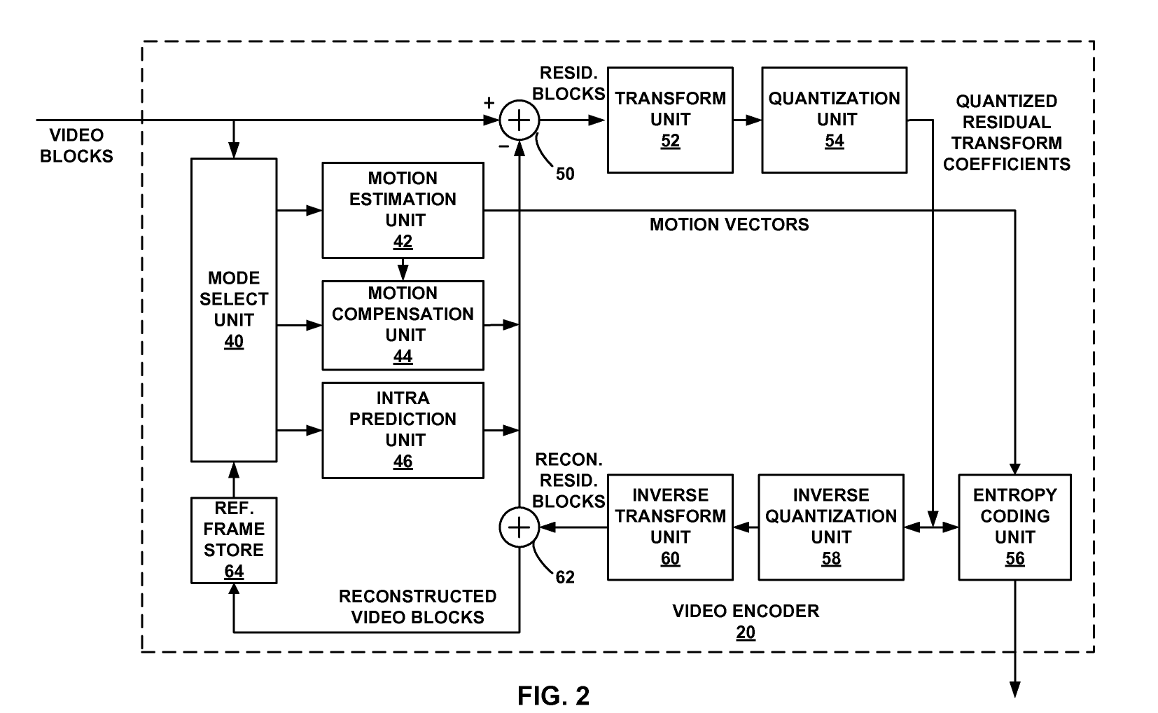

FIG. 2 is a block diagram illustrating an example of video encoder 20 that may implement techniques for selecting interpolation filters. Video encoder 20 may perform intra- and inter-coding of blocks within video frames, including macroblocks, or partitions or sub-partitions of macroblocks. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes and inter-modes such as uni-directional prediction (P-mode) or bi-directional prediction (B-mode) may refer to any of several temporal-based compression modes. Although components for inter-mode encoding are depicted in FIG. 2, it should be understood that video encoder 20 may further include components for intra-mode encoding. However, such components are not illustrated for the sake of brevity and clarity.

As shown in FIG. 2, video encoder 20 receives a current video block within a video frame to be encoded. In the example of FIG. 2, video encoder 20 includes motion compensation unit 44, motion estimation unit 42, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. An intra prediction unit may also perform intra-predictive coding of the received video block relative to one or more neighboring blocks in the same frame or slice as the block to be coded to provide spatial compression.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame.

Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a macroblock. Motion compensation may involve fetching or generating the predictive block based on the motion vector determined by motion estimation. Again, motion estimation unit 42 and motion compensation unit 44 may be functionally integrated, in some examples.

Motion estimation unit 42 calculates a motion vector for the video block of an inter-coded frame by comparing the video block to video blocks of a reference frame in reference frame store 64. Reference frame store 64 may comprise a reference frame buffer, which may be implemented in memory, such as random access memory (RAM). Motion compensation unit 44 may also interpolate sub-integer pixels of the reference frame, e.g., an I-frame or a P-frame. The ITU H.264 standard refers to reference frames as “lists.” Therefore, data stored in reference frame store 64 may also be considered lists. Motion estimation unit 42 compares blocks of one or more reference frames (or lists) from reference frame store 64 to a block to be encoded of a current frame, e.g., a P-frame or a B-frame. When the reference frames in reference frame store 64 include values for sub-integer pixels, a motion vector calculated by motion estimation unit 42 may refer to a sub-integer pixel location of a reference frame. Motion estimation unit 42 sends the calculated motion vector to entropy coding unit 56 and motion compensation unit 44. The reference frame block identified by a motion vector may be referred to as a predictive block. Motion compensation unit 44 calculates error values for the predictive block of the reference frame.

Motion compensation unit 44 may calculate prediction data based on the predictive block. For example, motion compensation unit 44 may calculate prediction data for both luminance and chrominance blocks of a macroblock. Motion compensation unit 44 may be configured to perform the techniques of this disclosure to calculate values for sub-integer pixel positions of a reference block to form a chrominance prediction block. Video encoder 20 forms a residual video block by subtracting the prediction data from motion compensation unit 44 from the original video block being coded. Summer 50 represents the component or components that perform this subtraction operation. Transform unit 52 applies a transform, such as a discrete cosine transform (DCT) or a conceptually similar transform, to the residual block, producing a video block comprising residual transform coefficient values.

Transform unit 52 may perform other transforms, such as those defined by the H.264 standard, which are conceptually similar to DCT. Wavelet transforms, integer transforms, sub-band transforms or other types of transforms could also be used. In any case, transform unit 52 applies the transform to the residual block, producing a block of residual transform coefficients. The transform may convert the residual information from a pixel value domain to a transform domain, such as a frequency domain. Quantization unit 54 quantizes the residual transform coefficients to further reduce bit rate. The quantization process may reduce the bit depth associated with some or all of the coefficients. The degree of quantization may be modified by adjusting a quantization parameter.

Following quantization, entropy coding unit 56 entropy codes the quantized transform coefficients. For example, entropy coding unit 56 may perform content adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of context adaptive binary arithmetic coding, context may be based on neighboring macroblocks.

In some cases, entropy coding unit 56 or another unit of video encoder 20 may be configured to perform other coding functions, in addition to entropy coding. For example, entropy coding unit 56 may be configured to determine the CBP values for the macroblocks and partitions. Also, in some cases, entropy coding unit 56 may perform run length coding of the coefficients in a macroblock or partition thereof. In particular, entropy coding unit 56 may apply a zig-zag scan or other scan pattern to scan the transform coefficients in a macroblock or partition and encode runs of zeros for further compression. Entropy coding unit 56 also may construct header information with appropriate syntax elements for transmission in the encoded video bitstream.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

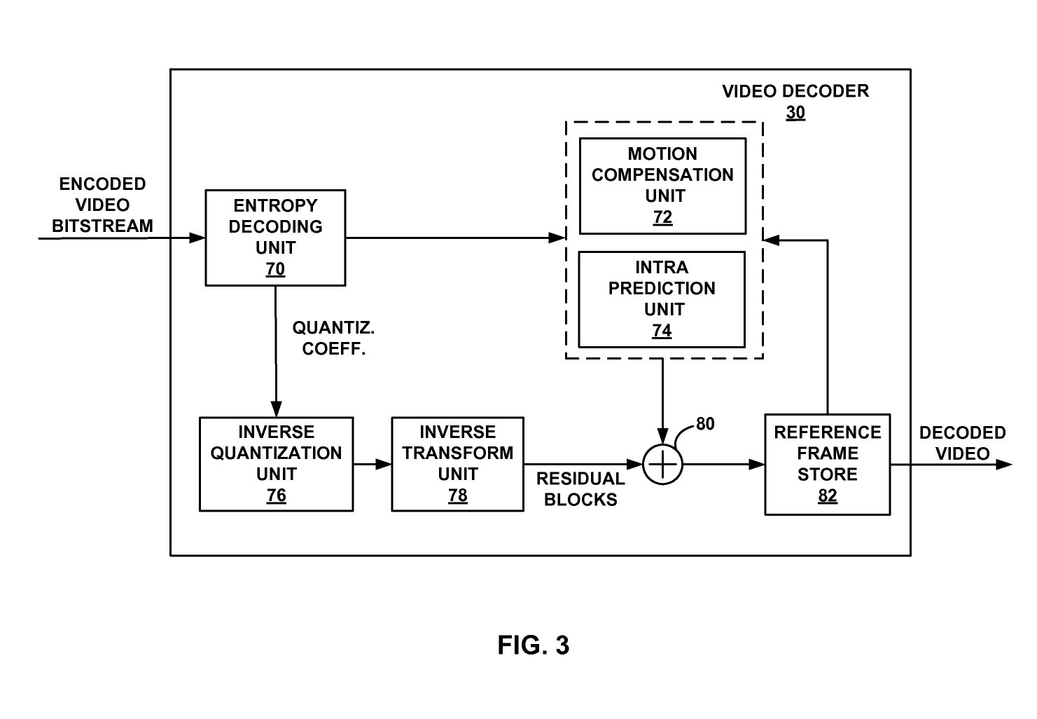

FIG. 3 is a block diagram illustrating an example of video decoder 30, which decodes an encoded video sequence. In the example of FIG. 3, video decoder 30 includes an entropy decoding unit 70, motion compensation unit 72, intra prediction unit 74, inverse quantization unit 76, inverse transformation unit 78, reference frame store 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

Motion compensation unit 72 may use motion vectors received in the bitstream to identify a prediction block in reference frames in reference frame store 82. Motion compensation unit 72 may also be configured to perform the techniques of this disclosure to calculate values for sub-integer pixel positions of a reference block to form a chrominance prediction block. Intra prediction unit 74 may use intra prediction modes received in the bitstream to form a prediction block from spatially adjacent blocks. Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard. The inverse quantization process may also include use of a quantization parameter QP_{Y} calculated by encoder 50 for each macroblock to determine a degree of quantization and, likewise, a degree of inverse quantization that should be applied.

Inverse transform unit 58 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information to determine sizes of macroblocks used to encode frame(s) of the encoded video sequence, partition information that describes how each macroblock of a frame of the encoded video sequence is partitioned, modes indicating how each partition is encoded, one or more reference frames (or lists) for each inter-encoded macroblock or partition, and other information to decode the encoded video sequence.

Summer 80 sums the residual blocks with the corresponding prediction blocks generated by motion compensation unit 72 or intra-prediction unit to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

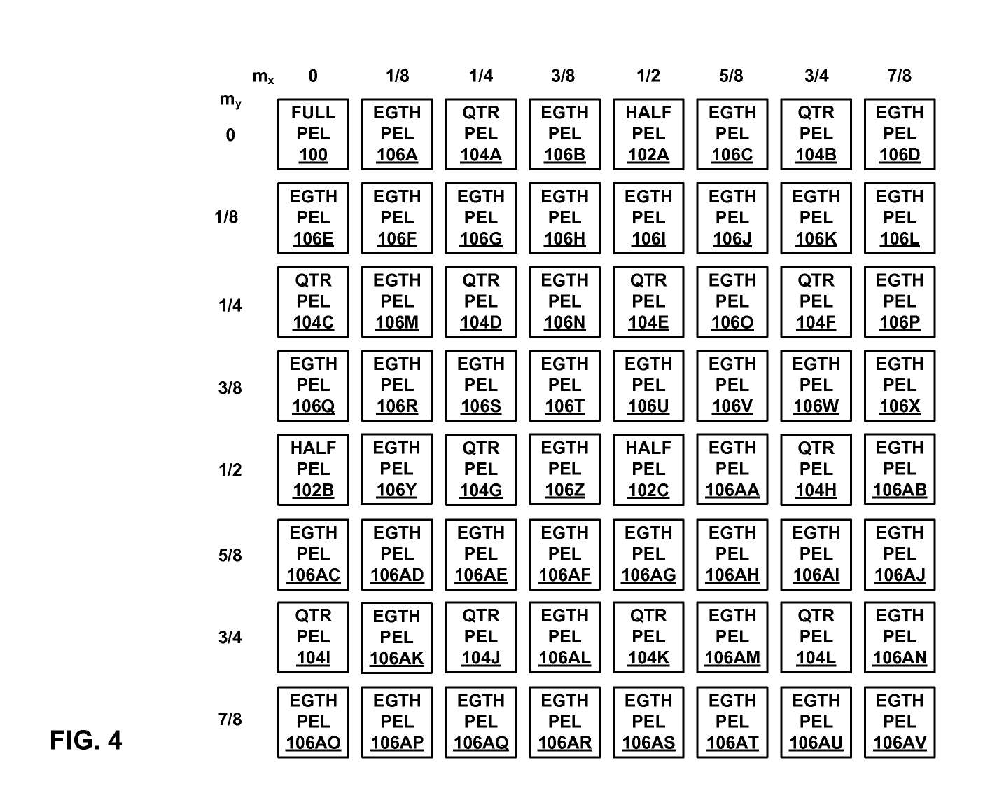

FIG. 4 is a conceptual diagram illustrating fractional pixel positions for a full pixel position. In particular, FIG. 4 illustrates fractional pixel positions for full pixel (pel) 100. Full pixel 100 corresponds to half-pixel positions 102A-102C (half pels 102), quarter pixel positions 104A-104L (quarter pels 104), and eighth-pixel positions 106A-106AV (egth pels 106). A motion vector pointing to one of these positions may have horizontal and vertical components with full portions corresponding to the location of full pel 100 and fractional portions with one-eighth-pixel precision.

A value for the pixel at full pixel position 100 may be included in a corresponding reference frame. That is, the value for the pixel at full pixel position 100 generally corresponds to the actual value of a pixel in the reference frame, e.g., that is ultimately rendered and displayed when the reference frame is displayed. Values for half pixel positions 102, quarter pixel positions 104, and eighth pixel positions 106 (collectively referred to as fractional pixel positions) may be interpolated in accordance with the techniques of this disclosure.

In particular, fractional positions may be defined using a fractional portion of a horizontal component and a fractional portion of a vertical component. Let the horizontal fractional portion correspond to mₓ, which may be selected from {0, ⅛, 2/8, ⅜, 4/8, ⅝, 6/8, ⅞}. Let the vertical fractional portion correspond to m_{y}, which may be selected from {0, ⅛, 2/8, ⅜, 4/8, ⅝, 6/8, ⅞}. Filter F₁ may be an interpolation filter associated with 2/8 (¼) fractional portions. Filter F₂ may be an interpolation filter associated with 4/8 (½) fractional portions. Filter F₃ may be an interpolation filter associated with 6/8 (¾) fractional portions. F₁, F₂, and F₃ may essentially be the same for both horizontal and vertical components, except that a line of reference pixels for a filter for the horizontal component may be orthogonal to a line of reference pixels for a filter for the vertical component.

Table 1 below summarizes the techniques for calculating a contribution of a component of a motion vector having one-eighth-pixel precision based on a fractional portion of the component. Table N below refers to a “neighboring pixel,” which is defined according to whether the component is a horizontal component or a vertical component. If the component is a horizontal component, neighboring pixel refers to a right-neighboring-pixel of full pixel 100. If the component is a vertical component, neighboring pixel refers to a below-neighboring-pixel of full pixel 100.

TABLE 1

| Fractional Portion | Value |
|---|---|
| 0 | Full Pixel Value (FPV) |
| ⅛ | (FPV + F₁)/2 |
| 2/8 | F₁ |
| ⅜ | (F₁ + F₂)/2 |
| 4/8 | F₂ |
| ⅝ | (F₂ + F₃)/2 |
| 6/8 | F₃ |
| ⅞ | (F₁ + FPV of neighboring pixel)/2 |

In this manner, when a component of a motion vector refers to a fractional pixel position that can be expressed by a motion vector having the precision of the luminance motion vector, video encoder 20 may select the interpolation filter associated with the fractional pixel position to interpolate the contribution for the component. On the other hand, when the component refers to a fractional pixel position that cannot be expressed by a motion vector having the precision of the luminance motion vector but can be expressed by a motion vector having the precision of the chrominance motion vector, video encoder 20 may select one or more interpolation filters for immediately neighboring fractional pixel positions.

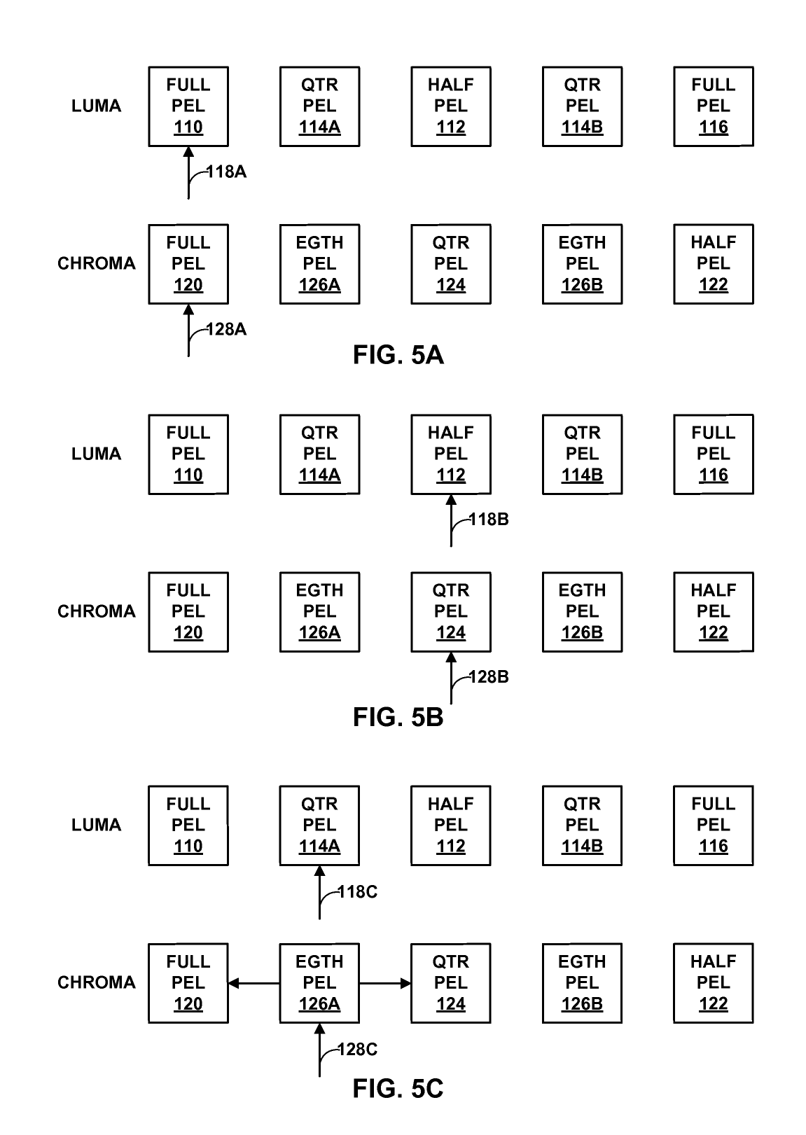

FIGS. 5A-5C are conceptual diagrams illustrating corresponding chrominance and luminance pixel positions. FIGS. 5A-5C also illustrate how luminance motion vectors can be reused for chrominance blocks. As a preliminary matter, FIGS. 5A-5C illustrate a partial row of pixel positions. It should be understood that in practice, a full pixel position may have a rectangular grid of associated fractional pixel positions. The example of FIGS. 5A-5C are intended to illustrate the concepts described in this disclosure, and are not intended as an exhaustive listing of correspondences between fractional chrominance pixel positions and fractional luminance pixel positions.

FIGS. 5A-5C illustrate pixel positions of a luminance block, including full luminance pixel position 110, half luminance pixel position 112, quarter luminance pixel positions 114A, 114B, and full luminance pixel position 116. Full luminance pixel position 116 may be considered a right-neighboring pixel position to full luminance pixel position 110.

FIGS. 5A-5C also illustrate corresponding pixel positions of a chrominance block, including full chrominance pixel position 120, half chrominance pixel position 122, quarter chrominance pixel position 124, and eighth chrominance pixel positions 126A, 126B. In this example, full chrominance pixel 120 corresponds to full luminance pixel 110. Further, in this example, the chrominance block is downsampled by a factor of two relative to the luminance block. Thus, half chrominance pixel 122 corresponds to full luminance pixel 116. Similarly, quarter chrominance pixel 124 corresponds to half luminance pixel 112, eighth chrominance pixel 126A corresponds to quarter luminance pixel 114A, and eighth chrominance pixel 126B corresponds to quarter luminance pixel 114B.

FIG. 5A illustrates an example of a luminance motion vector 118A pointing to full luminance pixel position 110. A video coding unit, such as video encoder 20 or video decoder 30, may reuse luminance motion vector 118A when performing motion compensation for a chrominance block. Accordingly, chrominance motion vector 128A may point to full chrominance pixel 120, due to the correspondence between full chrominance pixel 120 and full luminance pixel 110. The value of the pixel pointed to by chrominance motion vector 128A may be equal to the value of full chrominance pixel 120. Thus, each pixel in a prediction chrominance block may be set equal to a corresponding pixel in the reference frame.

FIG. 5B illustrates an example of a luminance motion vector 118B pointing to half luminance pixel position 112. Chrominance motion vector 128B, in turn, points to quarter chrominance pixel position 124. A video coding unit may interpolate a value for quarter chrominance pixel position 124 using an interpolation filter associated with quarter chrominance pixel position 124.

FIG. 5C illustrates an example of a luminance motion vector 118C pointing to quarter luminance pixel position 114A. Chrominance motion vector 128C, in turn, points to eighth chrominance pixel position 126A. A video coding unit may interpolate a value for quarter chrominance pixel position 124 using the value of full chrominance pixel position 120 and an interpolation filter associated with quarter chrominance pixel position 124, e.g., filter F₁. The video coding unit may then average the value of full chrominance pixel position 120 and the value of quarter chrominance pixel position 124 to produce a value for eighth chrominance pixel position 126A.

There are cases when even higher precision is used for luminance motion vectors (e.g. ⅛^{th}). In such a case, the chrominance pixel position may be rounded off (e.g., truncated) so that it still has a ⅛^{th} pixel precision. Accordingly, the techniques of this disclosure may still be applied to such a chrominance pixel position for determining a chrominance value at the chrominance pixel position, even though the chrominance and luminance motion vectors have equal precisions.

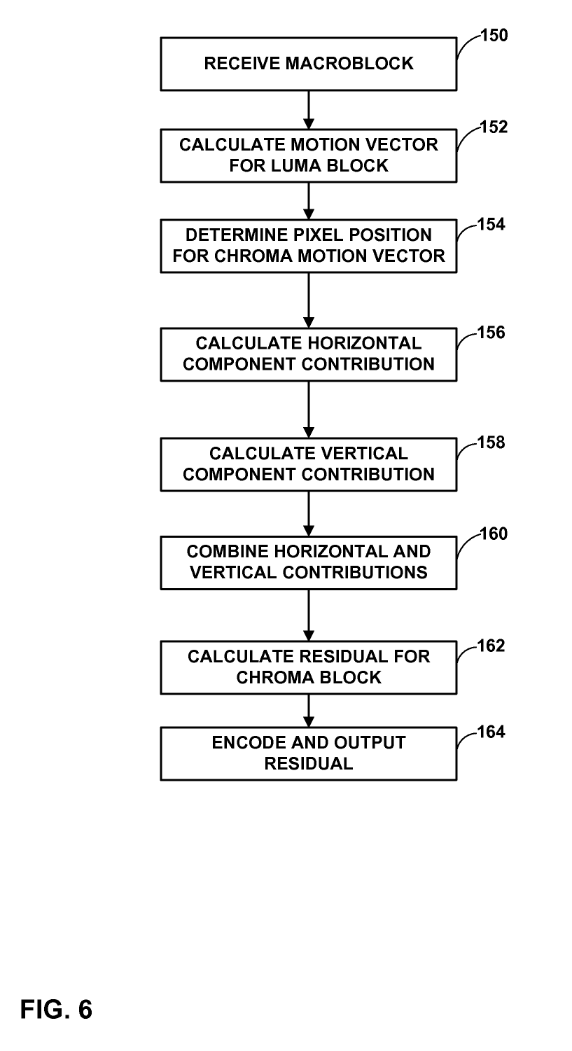

FIG. 6 is a flowchart illustrating an example method for interpolating values for fractional pixel positions to encode a chrominance block. The method of FIG. 6 is described with respect to video encoder 20 for purposes of illustration. However, it should be understood that any video encoding unit may be configured to perform methods similar to that of FIG. 6.

Initially, video encoder 20 may receive a macroblock to be encoded (150). In some examples, a macroblock may include four 8×8 pixel luminance blocks and two 8×8 chrominance blocks. The macroblock may have exactly one luminance block touching each corner, such that the four luminance blocks together form a 16×16 block of luminance pixels. The two chrominance blocks may overlap with each other and the four luminance blocks. Moreover, the chrominance blocks may be downsampled relative to the luminance blocks, such that each of the four corners of the chrominance blocks touch each of the four corners of the macroblock. Video encoder 20 may be configured to encode all or a portion (e.g., a partition) of either or both of the chrominance blocks using techniques similar to those described with respect to FIG. 6.

Video encoder 20 may encode the macroblock in an inter-encoding mode. Accordingly, video encoder 20 may perform a motion search with respect to one or more reference frames to determine a block in a reference frame that is similar to the macroblock. Furthermore, video encoder 20 may perform the motion search relative to one of the luminance blocks (152). Video encoder 20 may thereby calculate a luminance motion vector having fractional pixel precision. Video encoder 20 may be configured to interpolate values for fractional pixel positions of the reference block when performing the motion search. Video encoder 20 may then encode the luminance block.

After encoding the luminance block, video encoder 20 may reuse the luminance motion vector to determine a position in a chrominance portion of the reference frame corresponding to the position pointed to by the luminance motion vector. In this manner, video encoder 20 may determine a pixel position pointed to by a chrominance motion vector corresponding to the luminance motion vector (154). The pixel position for the chrominance motion vector may have greater precision than the luminance pixel, due to downsampling of chrominance pixels relative to luminance pixels. For example, the chrominance motion vector may have one-eighth-pixel precision when the luminance motion vector has one-quarter-pixel precision.

Video encoder 20 may then encode a chrominance block using the block of pixels identified by the chrominance motion vector. When the chrominance motion vector points to a fractional pixel position, video encoder 20 may interpolate values for the fractional pixel positions of the reference block identified by the chrominance motion vector in the reference frame. The pixel position for the chrominance motion vector may have a horizontal component and a vertical component, each of which may have full and fractional portions. Video encoder 20 may first calculate a horizontal contribution to the values of each of the pixels in the reference block (156).

In particular, video encoder 20 may determine whether the horizontal component of the chrominance motion vector points to the full pixel position or a fractional pixel position. If the horizontal component points to a fractional portion, video encoder 20 may select interpolation filters based on the fractional portion to use to interpolate a contribution from the horizontal component. Likewise, video encoder 20 may calculate a vertical component contribution (158). Video encoder 20 may combine the horizontal component contribution and the vertical component contribution (160).

Video encoder 20 may perform this process for each pixel of the reference block. Then, video encoder 20 may calculate a residual value for the chrominance block to be encoded (162). That is, video encoder 20 may calculate a difference between the chrominance block to be encoded and the reference block. Video encoder 20 may then encode and output the residual (164). Video encoder 20 need not encode the chrominance motion vector, as a decoder may reuse the luminance motion vector to decode the encoded chrominance block after receiving the encoded residual block for the chrominance block.

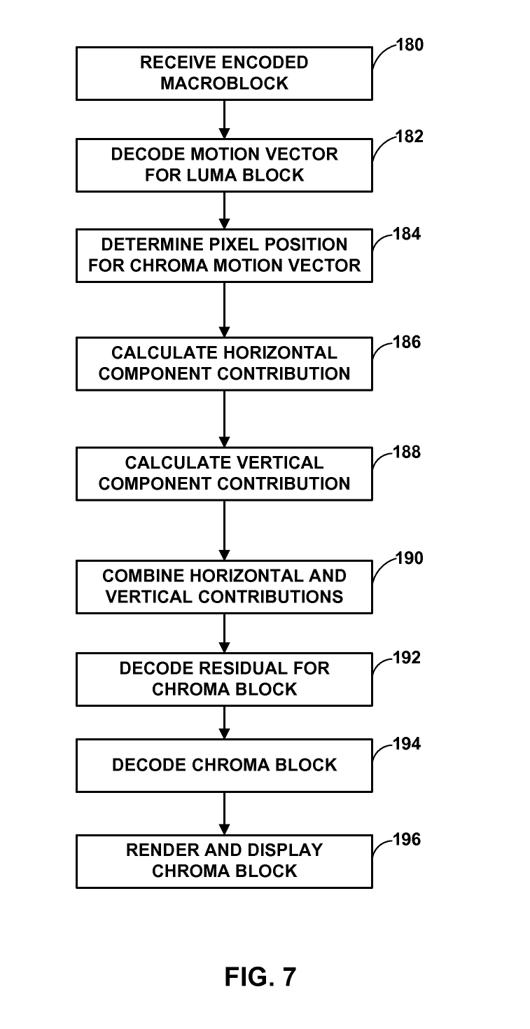

FIG. 7 is a flowchart illustrating an example method for interpolating values for fractional pixel positions to decode a chrominance block. The method of FIG. 7 is described with respect to video decoder 30 for purposes of illustration. However, it should be understood that any video decoding unit may be configured to perform methods similar to that of FIG. 7.

Initially, video decoder 30 may receive an encoded macroblock (180). In particular, video decoder 30 may receive a macroblock that was encoded in an inter-encoding mode. Thus, the encoded macroblock may include one or more luminance motion vectors and residual values for encoded luminance blocks and chrominance blocks of the macroblock. Video decoder 30 may first decode the luminance motion vector (182). After decoding the luminance blocks, video decoder 30 may decode the chrominance blocks.

First, video decoder 30 may identify a reference block of a reference frame for an encoded chrominance block. The reference block may be identified as being collocated with a reference block for an encoded luminance block. That is, video decoder 30 may reuse the luminance motion vector to identify the reference block for the encoded chrominance block. Video decoder 30 may then interpolate values for the reference block for the encoded chrominance block in accordance with the techniques of this disclosure.

Video decoder 30 may determine a fractional pixel position for pixels in the reference block (184). When the chrominance motion vector points to a fractional pixel position, video decoder 30 may interpolate values for the fractional pixel positions of the reference block. The pixel position for the chrominance motion vector may have a horizontal component and a vertical component, each of which may have full and fractional portions. Video decoder 30 may first calculate a horizontal contribution to the values of each of the pixels in the reference block (186).

In particular, video decoder 30 may determine whether the horizontal component of the chrominance motion vector points to the full pixel position or a fractional pixel position. If the horizontal component points to a fractional portion, video encoder 20 may select interpolation filters based on the fractional portion to use to interpolate a contribution from the horizontal component. Likewise, video decoder 30 may calculate a vertical component contribution (188). Video decoder 30 may combine the horizontal component contribution and the vertical component contribution (190).

Video decoder 30 may then decode the residual value for the chrominance block (192). Video decoder 30 may then combine the decoded residual value and the reference block calculated above to decode the chrominance block (194). In this manner, video decoder 30 may decode the chrominance block using the decoded residual value and the reference block. Ultimately, display device 32 may render and display the decoded chrominance block (196). That is, display device 32 (or another unit of destination device 14) may determine luminance values for pixels that are displayed from the decoded luminance blocks and color values from the decoded chrominance blocks. Display device 32 may convert pixels expressed in luminance and chrominance (YPbPr values) to red-green-blue (RGB) values in order to display the macroblock including the luminance and chrominance values.

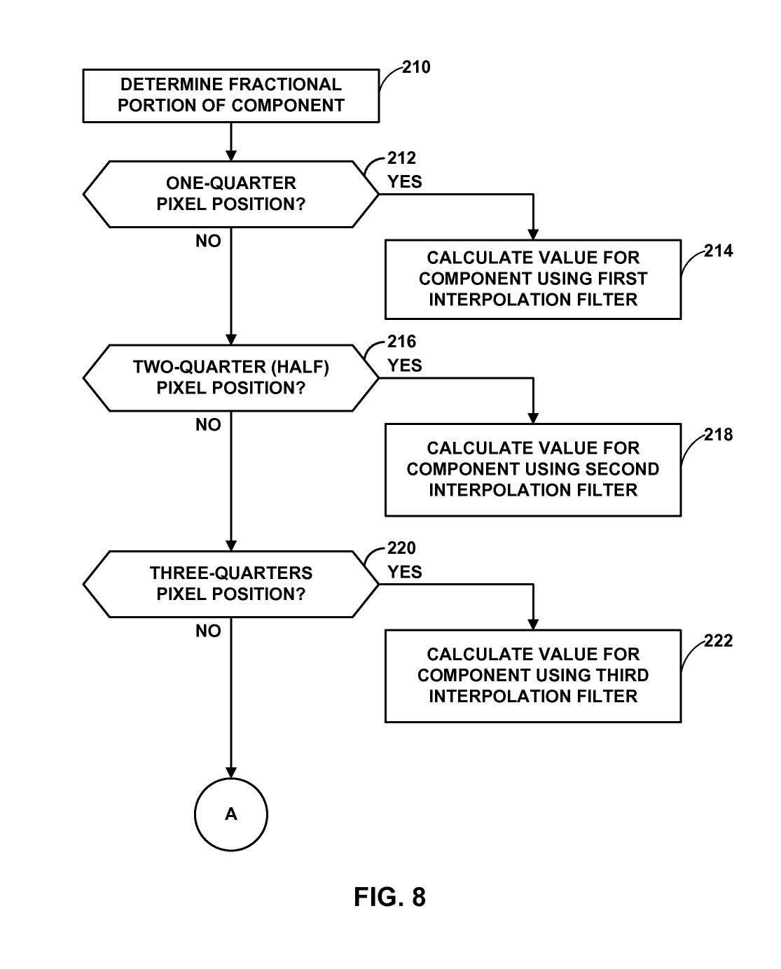

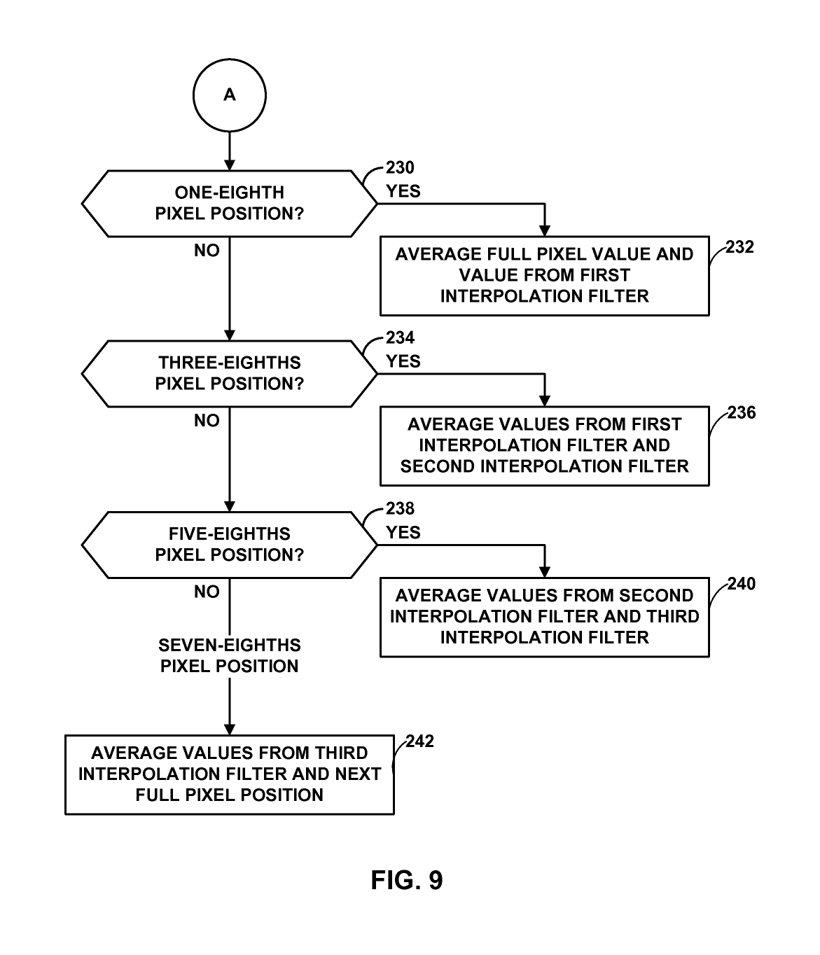

FIGS. 8 and 9 are flowcharts illustrating methods for selecting interpolation filters to be used to calculate component contributions for both horizontal and vertical components. In particular, a video encoder, decoder, CODEC, or other video processing unit may execute the methods of FIGS. 8 and 9 to interpolate values for reference blocks when a component of a chrominance motion vector includes a non-zero fractional portion. The examples of FIGS. 8 and 9 are directed to situations where the chrominance motion vector has one-eighth-pixel precision. It should be understood that similar methods may be applied to calculate values for reference blocks when motion vectors have greater precision than one-eighth-pixel precision. Moreover, the examples of FIGS. 8 and 9 are described with respect to video encoder 20. However, it should be understood that similar techniques may be applied by video decoder 30 or other video processing units. The examples of FIGS. 8 and 9 may generally correspond to steps 156 and 158 of FIG. 6 and steps 186 and 188 of FIG. 7.

Initially, video encoder 20 may determine a fractional portion of a component of a motion vector (210). It is assumed that the fractional portion is non-zero when the method of FIG. 6 is executed. If instead the fractional portion is zero, the value of the full pixel may be used for the component (or the value of the other component may be used, if the other component was already calculated). It is also assumed, in the example of FIG. 6, that interpolation filters F₁, F₂, and F₃ are associated with the one-quarter, two-quarters, and three-quarters fractional pixel positions, respectively, when these methods are executed.

Video encoder 20 may first determine whether the fractional portion of the component corresponds to one of the three quarter-pixel positions. In particular, video encoder 20 may determine whether the fractional portion of the component corresponds to the one-quarter pixel position (212). If so (“YES” branch of 212), video encoder 20 may determine the contribution from the component based on the value produced by executing filter F₁ (214). On the other hand, (“NO” branch of 212), video encoder 20 may determine whether the fractional portion of the component corresponds to the two-quarters (or one-half) pixel position (216). If so (“YES” branch of 216), video encoder 20 may determine the contribution from the component based on the value produced by executing filter F₂ (218). On the other hand, (“NO” branch of 216), video encoder 20 may determine whether the fractional portion of the component corresponds to the three-quarters pixel position (220). If so (“YES” branch of 220), video encoder 20 may determine the contribution from the component based on the value produced by executing filter F₃ (222).

However, if video encoder 20 determines that the fractional portion of the component does not correspond to one of the three quarter-pixel positions, then video encoder 20 may determine whether the fractional portion of the component corresponds to one of the four remaining eighth-pixel positions. In particular, video encoder 20 may determine whether the fractional portion of the component corresponds to the one-eighth pixel position (230). If so (“YES” branch of 230), video encoder 20 may determine the contribution from the component by averaging the full pixel value and the value produced by executing filter F₁ (232). In some examples, rather than using the full pixel value, video encoder 20 may use the value of a position at the intersection of the full pixel and the pixel position being evaluated, assuming that a value for this position at the intersection has previously been calculated.

On the other hand, if the fractional portion of the component does not correspond to the one-eighth pixel position (“NO” branch of 230), video encoder 20 may determine whether the fractional portion of the component corresponds to the three-eighths pixel position (234). If the fractional portion of the component corresponds to the three-eighths pixel position (“YES” branch of 234), video encoder 20 may determine the contribution from the component by averaging the value produced by executing filter F₁ and the value produced by executing filter F₂ (236). On the other hand, if the fractional portion of the component does not correspond to the three-eighths pixel position (“NO” branch of 234), video encoder 20 may determine whether the fractional portion of the component corresponds to the five-eighths pixel position (238). If the fractional portion of the component corresponds to the five-eighths pixel position (“YES” branch of 238), video encoder 20 may determine the contribution from the component by averaging the value produced by executing filter F₂ and the value produced by executing filter F₃ (240).

On the other hand, if the fractional portion of the component does not correspond to the five-eighths pixel position (“NO” branch of 238), that is, when the fractional portion of the component corresponds to the seven-eighths position, video encoder 20 may determine the contribution from the component by averaging the value produced by executing filter F₃ and the value of the next full pixel position (242). In some examples, rather than using the full pixel value of the next full pixel, video encoder 20 may use the value of a position at the intersection of the next full pixel and the pixel position being evaluated, assuming that a value for this position at the intersection has previously been calculated.

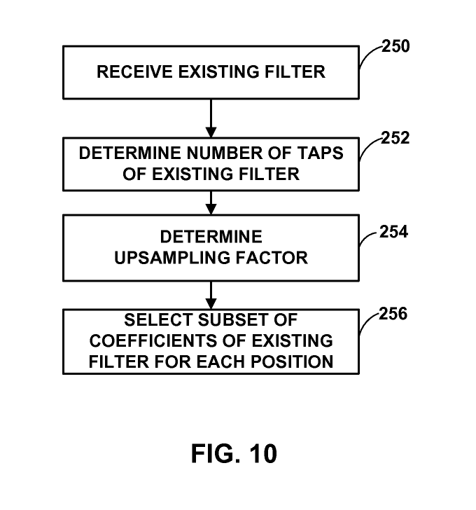

FIG. 10 is a flowchart illustrating an example method for creating, from an existing up-sampling filter, interpolation filters to be used in accordance with the techniques of this disclosure. For example, the method of FIG. 10 may be used to design filters F₁, F₂, and F₃ associated with one-quarter-pixel positions of a chrominance reference block, for which a chrominance motion vector may have one-eighth-pixel precision. Although described with respect to video encoder 20, other processing units may perform the method of FIG. 10. In one example, where video encoder 20 performs this method, video encoder 20 may encode and transmit the coefficients of each filter to video decoder 30. The existing up-sampling filter, when applied to a known pixel, should produce the value of the known pixel.

Initially, video encoder 20 may receive an existing filter (250). Interpolation filters generally have a number of coefficients, also referred to as “taps.” Video encoder 20 may determine the number of taps of the existing filter (252). The number of taps may be expressed by (2M+1), where the taps are centered around 0 and M is a nonnegative integer. Then, video encoder 20 may determine an upsampling factor (expressed as N, a nonnegative integer) (254). For example, to produce filters F₁, F₂, and F₃ from the existing filter, the upsampling factor (N) is four. In general, the upsampling factor may refer to the number of positions with which filters to be produced will be associated, plus one.

Video encoder 20 may then select a subset of the taps of the existing filter for each of the fractional pixel positions (256). In particular, let i refer to a particular coefficient of the existing filter. That is, the existing filter h includes coefficients −M to M, such that i has a range [−M, M]. Then, for fractional pixel position x, if (i+x)%N=0, the coefficient for i from the filter is included in the created filter for position x. Note that the modulo operator % may be defined as A % B=R, where A and B are integer values, and R is a nonnegative integer value less than B such that for some integer value C, A*C+R=B. Thus, A % B may produce a different remainder R value than −A % B.

As an example, an existing up-sampling filter h may have 23 coefficients, e.g., M=11, and the upsampling factor may be 4, to create three filters respectively associated with a one-quarter, a two-quarters (or half), and a three-quarters pixel position. Then the set of coefficients of the filter associated with position x=1 (corresponding to the one-quarter pixel position) may include {h[−9], h[−5], h[−1], h[3], h[7], h[11]}. The set of coefficients of the filter associated with position x=2 (corresponding to the two-quarters pixel position) may include {h[−10], h[−6], h[−2], h[2], h[6], h[10]}, and the set of coefficients of the filter associated with position x=3 (corresponding to the two-quarters pixel position) may include {h[−11], h[−7], h[−3], h[1], h[5], h[9]}.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

In some examples, the filters produced by the example method above may be further refined. For example, for each filter, one may ensure that the coefficients sum up to one. This may avoid introducing a DC bias for interpolated values. As another example, for the original low pass filter h[n], one may ensure that h[0]=1 and h[N*n]=0, where n is not equal to 0. This may avoid affecting original samples of x[n] when filtering.

For implementation purposes, filter coefficients may be expressed as fractions where all the coefficients have a common denominator that is a power of 2. For example, the common denominator may be 32. When executing the filter, the filter coefficients may be multiplied by the common denominator (e.g., 32) and rounded off to the nearest integer. Further adjustment by ±1 may be made to ensure that the filter coefficients sum up to the common denominator, e.g., 32.

It is to be recognized that while embodiments disclosed herein are discussed with respect to encoding of “macroblocks,” the systems and methods discussed herein apply to any suitable partitioning of pixels defining units of video data. In particular, the term “block” can refer to any suitable partitioning of video data into units for processing and coding.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, non-transitory, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of coding video data, the method comprising:
determining a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision;
selecting interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector;
interpolating values for a reference block identified by the chrominance motion vector using the selected interpolation filters; and
processing the chrominance block using the reference block.

2. The method of claim 1, wherein the luminance motion vector has one-quarter-pixel precision, and wherein the chrominance motion vector has one-eighth-pixel precision.

3. The method of claim 1, wherein the luminance motion vector has one-eighth-pixel precision, and wherein the chrominance motion vector has one-eighth-pixel precision after truncating a one-sixteenth-pixel precision motion vector.

4. The method of claim 1, wherein selecting the interpolation filters comprises selecting an interpolation filter associated with a fractional pixel position corresponding to the first fractional portion when the first fractional portion can be expressed by a motion vector having the first precision.

5. The method of claim 1, wherein selecting the interpolation filters comprises selecting at least one interpolation filter associated with a fractional pixel position that neighbors a fractional pixel position corresponding to the first fractional portion when the first fractional portion cannot be expressed by a motion vector having the first precision but can be expressed by a motion vector having the second precision.

6. The method of claim 1, wherein selecting the interpolation filters comprises:
identifying a referenced fractional pixel position identified by the first fractional portion;
selecting a first interpolation filter when the first interpolation filter is associated with a fractional pixel position to the immediate left of the referenced fractional pixel position; and
selecting a second interpolation filter when the second interpolation filter is associated with a fractional pixel position to the immediate right of the referenced fractional pixel position.

7. The method of claim 6, wherein interpolating values for the reference block comprises:
averaging a horizontal contribution value for the referenced fractional pixel position from a value produced by the first interpolation filter and a value produced by the second interpolation filter when the first interpolation filter is associated with the fractional pixel position to the immediate left of the referenced fractional pixel position and when the second interpolation filter is associated with the fractional pixel position to the immediate right of the referenced fractional pixel position;
averaging the horizontal contribution value for the referenced fractional pixel position from a value of a fractional pixel position to the immediate left of the referenced fractional pixel position and a value produced by the first interpolation filter when the first interpolation filter is associated with the fractional pixel position to the immediate right of the referenced fractional pixel position and when the fractional pixel position to the immediate left of the referenced fractional pixel position is vertically collocated with a full pixel position; and
averaging the horizontal contribution value for the referenced fractional pixel position from a value of a fractional pixel position to the immediate right of the referenced fractional pixel position and a value produced by the second interpolation filter when the second interpolation filter is associated with the fractional pixel position to the immediate left of the referenced fractional pixel position and when the fractional pixel position to the immediate right of the referenced fractional pixel position is vertically collocated with a right-neighboring full pixel position.

8. The method of claim 7, further comprising performing a rounding operation only after averaging the horizontal contribution value.

9. The method of claim 1, wherein selecting the interpolation filters comprises selecting an interpolation filter associated with a fractional pixel position corresponding to the second fractional portion when the second fractional portion can be expressed by a motion vector having the first precision.

10. The method of claim 1, wherein selecting the interpolation filters comprises selecting at least one interpolation filter associated with a fractional pixel position that neighbors a fractional pixel position corresponding to the second fractional portion when the second fractional portion cannot be expressed by a motion vector having the first precision but can be expressed by a motion vector having the second precision.

11. The method of claim 1, wherein selecting the interpolation filters comprises:
identifying a referenced fractional pixel position identified by the second fractional portion;
selecting a first interpolation filter when the first interpolation filter is associated with a fractional pixel position immediately above the referenced fractional pixel position; and
selecting a second interpolation filter when the second interpolation filter is associated with a fractional pixel position immediately below the referenced fractional pixel position.

12. The method of claim 11, wherein interpolating values for the reference block comprises:
averaging a vertical contribution value for the referenced fractional pixel position from a value produced by the first interpolation filter and a value produced by the second interpolation filter when the first interpolation filter is associated with the fractional pixel position immediately above the referenced fractional pixel position and when the second interpolation filter is associated with the fractional pixel position immediately below the referenced fractional pixel position;
averaging the vertical contribution value for the referenced fractional pixel position from a value of a fractional pixel position immediately above the referenced fractional pixel position and a value produced by the first interpolation filter when the first interpolation filter is associated with the fractional pixel position immediately below the referenced fractional pixel position and when the fractional pixel position immediately above the referenced fractional pixel position is horizontally collocated with a full pixel position; and
averaging the vertical contribution value for the referenced fractional pixel position from a value of a fractional pixel position immediately below the referenced fractional pixel position and a value produced by the second interpolation filter when the second interpolation filter is associated with the fractional pixel position immediately above the referenced fractional pixel position and when the fractional pixel position immediately below the referenced fractional pixel position is horizontally collocated with a below-neighboring full pixel position.

13. The method of claim 12, further comprising performing a rounding operation only after averaging the vertical contribution value.

14. The method of claim 1, further comprising producing the set of interpolation filters from an existing upsampling filter such that each of the interpolation filters is associated with a fractional pixel position that can be referred to by a motion vector having the first precision.

15. The method of claim 1,
wherein determining the chrominance motion vector comprises calculating the luminance motion vector to encode a macroblock comprising the chrominance block and the luminance block, and
wherein processing the chrominance block comprises:
calculating a residual chrominance value for the chrominance block based on the difference between the chrominance block and the reference block; and
outputting the residual chrominance value.

16. The method of claim 1,
wherein determining the chrominance motion vector comprises decoding the luminance motion vector for an encoded macroblock comprising the chrominance block and the luminance block, and
wherein processing the chrominance block comprises:
decoding a residual chrominance value for the chrominance block; and
decoding the chrominance block using the reference block and the decoded residual chrominance value.

17. An apparatus for coding video data, the apparatus comprising a video coding unit configured to:
determine a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision;
select interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector;
interpolate values for a reference block identified by the chrominance motion vector using the selected interpolation filters; and
process the chrominance block using the reference block.

18. The apparatus of claim 17, wherein the luminance motion vector has one-quarter-pixel precision, and wherein the chrominance motion vector has one-eighth-pixel precision.

19. The apparatus of claim 17, wherein to select the interpolation filters, the video coding unit is configured to select an interpolation filter associated with a fractional pixel position corresponding to the first fractional portion when the first fractional portion can be expressed by a motion vector having the first precision.

20. The apparatus of claim 17, wherein to select the interpolation filters, the video coding unit is configured to select at least one interpolation filter associated with a fractional pixel position that neighbors a fractional pixel position corresponding to the first fractional portion when the first fractional portion cannot be expressed by a motion vector having the first precision but can be expressed by a motion vector having the second precision.

21. The apparatus of claim 17, wherein to select the interpolation filters, the video coding unit is configured to:
identify a referenced fractional pixel position identified by the first fractional portion;
select a first interpolation filter when the first interpolation filter is associated with a fractional pixel position to the immediate left of the referenced fractional pixel position; and
select a second interpolation filter when the second interpolation filter is associated with a fractional pixel position to the immediate right of the referenced fractional pixel position.

22. The apparatus of claim 21, wherein to interpolate values for the reference block, the video coding unit is configured to:
average a horizontal contribution value for the referenced fractional pixel position from a value produced by the first interpolation filter and a value produced by the second interpolation filter when the first interpolation filter is associated with the fractional pixel position to the immediate left of the referenced fractional pixel position and when the second interpolation filter is associated with the fractional pixel position to the immediate right of the referenced fractional pixel position;
average the horizontal contribution value for the referenced fractional pixel position from a value of a fractional pixel position to the immediate left of the referenced fractional pixel position and a value produced by the first interpolation filter when the first interpolation filter is associated with the fractional pixel position to the immediate right of the referenced fractional pixel position and when the fractional pixel position to the immediate left of the referenced fractional pixel position is vertically collocated with a full pixel position; and
average the horizontal contribution value for the referenced fractional pixel position from a value of a fractional pixel position to the immediate right of the referenced fractional pixel position and a value produced by the second interpolation filter when the second interpolation filter is associated with the fractional pixel position to the immediate left of the referenced fractional pixel position and when the fractional pixel position to the immediate right of the referenced fractional pixel position is vertically collocated with a right-neighboring full pixel position.

23. The apparatus of claim 17, wherein to select the interpolation filters, the video coding unit is configured to select an interpolation filter associated with a fractional pixel position corresponding to the second fractional portion when the second fractional portion can be expressed by a motion vector having the first precision.

24. The apparatus of claim 17, wherein to select the interpolation filters, the video coding unit is configured to select at least one interpolation filter associated with a fractional pixel position that neighbors a fractional pixel position corresponding to the second fractional portion when the second fractional portion cannot be expressed by a motion vector having the first precision but can be expressed by a motion vector having the second precision.

25. The apparatus of claim 17, wherein to select the interpolation filters, the video coding unit is configured to:
identify a referenced fractional pixel position identified by the second fractional portion;
select a first interpolation filter when the first interpolation filter is associated with a fractional pixel position immediately above the referenced fractional pixel position; and
select a second interpolation filter when the second interpolation filter is associated with a fractional pixel position immediately below the referenced fractional pixel position.

26. The apparatus of claim 25, wherein to interpolate values for the reference block, the video coding unit is configured to:
average a vertical contribution value for the referenced fractional pixel position from a value produced by the first interpolation filter and a value produced by the second interpolation filter when the first interpolation filter is associated with the fractional pixel position immediately above the referenced fractional pixel position and when the second interpolation filter is associated with the fractional pixel position immediately below the referenced fractional pixel position;
average the vertical contribution value for the referenced fractional pixel position from a value of a fractional pixel position immediately above the referenced fractional pixel position and a value produced by the first interpolation filter when the first interpolation filter is associated with the fractional pixel position immediately below the referenced fractional pixel position and when the fractional pixel position immediately above the referenced fractional pixel position is horizontally collocated with a full pixel position; and
average the vertical contribution value for the referenced fractional pixel position from a value of a fractional pixel position immediately below the referenced fractional pixel position and a value produced by the second interpolation filter when the second interpolation filter is associated with the fractional pixel position immediately above the referenced fractional pixel position and when the fractional pixel position immediately below the referenced fractional pixel position is horizontally collocated with a below-neighboring full pixel position.

27. The apparatus of claim 17, wherein the video coding unit is configured to produce the set of interpolation filters from an existing upsampling filter such that each of the interpolation filters is associated with a fractional pixel position that can be referred to by a motion vector having the first precision.

28. The apparatus of claim 17, wherein to process the chrominance block, the video coding unit is configured to:
calculate a residual chrominance value for the chrominance block based on the difference between the chrominance block and the reference block; and
output the residual chrominance value.

29. The apparatus of claim 17, wherein to process the chrominance block, the video coding unit is configured to:
reconstruct the chrominance block from the reference block and a received residual chrominance value.

30. An apparatus for coding video data, the apparatus comprising:
means for determining a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision;
means for selecting interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector;
means for interpolating values for a reference block identified by the chrominance motion vector using the selected interpolation filters; and
means for processing the chrominance block using the reference block.

31. The apparatus of claim 30, wherein the luminance motion vector has one-quarter-pixel precision, and wherein the chrominance motion vector has one-eighth-pixel precision.

32. The apparatus of claim 30, wherein the means for selecting the interpolation filters comprises means for selecting an interpolation filter associated with a fractional pixel position corresponding to the first fractional portion when the first fractional portion can be expressed by a motion vector having the first precision.

33. The apparatus of claim 30, wherein the means for selecting the interpolation filters comprises means for selecting at least one interpolation filter associated with a fractional pixel position that neighbors a fractional pixel position corresponding to the first fractional portion when the first fractional portion cannot be expressed by a motion vector having the first precision but can be expressed by a motion vector having the second precision.

34. The apparatus of claim 30, wherein the means for selecting the interpolation filters comprises:
means for identifying a referenced fractional pixel position identified by the first fractional portion;
means for selecting a first interpolation filter when the first interpolation filter is associated with a fractional pixel position to the immediate left of the referenced fractional pixel position; and
means for selecting a second interpolation filter when the second interpolation filter is associated with a fractional pixel position to the immediate right of the referenced fractional pixel position.

35. The apparatus of claim 34, wherein the means for interpolating values for the reference block comprises:
means for averaging a horizontal contribution value for the referenced fractional pixel position from a value produced by the first interpolation filter and a value produced by the second interpolation filter when the first interpolation filter is associated with the fractional pixel position to the immediate left of the referenced fractional pixel position and when the second interpolation filter is associated with the fractional pixel position to the immediate right of the referenced fractional pixel position;
means for averaging the horizontal contribution value for the referenced fractional pixel position from a value of a fractional pixel position to the immediate left of the referenced fractional pixel position and a value produced by the first interpolation filter when the first interpolation filter is associated with the fractional pixel position to the immediate right of the referenced fractional pixel position and when the fractional pixel position to the immediate left of the referenced fractional pixel position is vertically collocated with a full pixel position; and
means for averaging the horizontal contribution value for the referenced fractional pixel position from a value of a fractional pixel position to the immediate right of the referenced fractional pixel position and a value produced by the second interpolation filter when the second interpolation filter is associated with the fractional pixel position to the immediate left of the referenced fractional pixel position and when the fractional pixel position to the immediate right of the referenced fractional pixel position is vertically collocated with a right-neighboring full pixel position.

36. The apparatus of claim 30, wherein the means for selecting the interpolation filters comprises means for selecting an interpolation filter associated with a fractional pixel position corresponding to the second fractional portion when the second fractional portion can be expressed by a motion vector having the first precision.

37. The apparatus of claim 30, wherein the means for selecting the interpolation filters comprises means for selecting at least one interpolation filter associated with a fractional pixel position that neighbors a fractional pixel position corresponding to the second fractional portion when the second fractional portion cannot be expressed by a motion vector having the first precision but can be expressed by a motion vector having the second precision.

38. The apparatus of claim 30, wherein the means for selecting the interpolation filters comprises:
means for identifying a referenced fractional pixel position identified by the second fractional portion;
means for selecting a first interpolation filter when the first interpolation filter is associated with a fractional pixel position immediately above the referenced fractional pixel position; and
means for selecting a second interpolation filter when the second interpolation filter is associated with a fractional pixel position immediately below the referenced fractional pixel position.

39. The apparatus of claim 38, wherein the means for interpolating values for the reference block comprises:
means for averaging a vertical contribution value for the referenced fractional pixel position from a value produced by the first interpolation filter and a value produced by the second interpolation filter when the first interpolation filter is associated with the fractional pixel position immediately above the referenced fractional pixel position and when the second interpolation filter is associated with the fractional pixel position immediately below the referenced fractional pixel position;
means for averaging the vertical contribution value for the referenced fractional pixel position from a value of a fractional pixel position immediately above the referenced fractional pixel position and a value produced by the first interpolation filter when the first interpolation filter is associated with the fractional pixel position immediately below the referenced fractional pixel position and when the fractional pixel position immediately above the referenced fractional pixel position is horizontally collocated with a full pixel position; and
means for averaging the vertical contribution value for the referenced fractional pixel position from a value of a fractional pixel position immediately below the referenced fractional pixel position and a value produced by the second interpolation filter when the second interpolation filter is associated with the fractional pixel position immediately above the referenced fractional pixel position and when the fractional pixel position immediately below the referenced fractional pixel position is horizontally collocated with a below-neighboring full pixel position.

40. The apparatus of claim 30, further comprising means for producing the set of interpolation filters from an existing upsampling filter such that each of the interpolation filters is associated with a fractional pixel position that can be referred to by a motion vector having the first precision.

41. The apparatus of claim 30, wherein the means for processing the chrominance block comprises:
means for calculating a residual chrominance value for the chrominance block based on the difference between the chrominance block and the reference block; and
means for outputting the residual chrominance value.

42. The apparatus of claim 30, wherein the means for processing the chrominance block comprises:
means for reconstructing the chrominance block from the reference block and a received residual chrominance value.

43. A computer program product comprising a computer-readable medium having stored thereon instructions that, when executed, cause a processor to:
determine a chrominance motion vector for a chrominance block of video data based on a luminance motion vector for a luminance block of video data corresponding to the chrominance block, wherein the chrominance motion vector comprises a horizontal component having a first fractional portion and a vertical component having a second fractional portion, wherein the luminance motion vector has a first precision, and wherein the chrominance motion vector has a second precision greater than or equal to the first precision;
select interpolation filters based on the first fractional portion of the horizontal component and the second fractional portion of the vertical component, wherein selecting the interpolation filters comprises selecting the interpolation filters from a set of interpolation filters, each of the set of interpolation filters corresponding to one of a plurality of possible fractional pixel positions of the luminance motion vector;
interpolate values for a reference block identified by the chrominance motion vector using the selected interpolation filters; and
process the chrominance block using the reference block.

44. The computer program product of claim 43, wherein the luminance motion vector has one-quarter-pixel precision, and wherein the chrominance motion vector has one-eighth-pixel precision.

45. The computer program product of claim 43, wherein the instructions that cause the processor to select the interpolation filters comprise instructions that cause the processor to select an interpolation filter associated with a fractional pixel position corresponding to the first fractional portion when the first fractional portion can be expressed by a motion vector having the first precision.

46. The computer program product of claim 43, wherein the instructions that cause the processor to select the interpolation filters comprise instructions that cause the processor to select at least one interpolation filter associated with a fractional pixel position that neighbors a fractional pixel position corresponding to the first fractional portion when the first fractional portion cannot be expressed by a motion vector having the first precision but can be expressed by a motion vector having the second precision.

47. The computer program product of claim 43, wherein the instructions that cause the processor to select the interpolation filters comprise instructions that cause the processor to:
identify a referenced fractional pixel position identified by the first fractional portion;
select a first interpolation filter when the first interpolation filter is associated with a fractional pixel position to the immediate left of the referenced fractional pixel position; and
select a second interpolation filter when the second interpolation filter is associated with a fractional pixel position to the immediate right of the referenced fractional pixel position.

48. The computer program product of claim 47, wherein the instructions that cause the processor to interpolate values for the reference block comprise instructions that cause the processor to:
average a horizontal contribution value for the referenced fractional pixel position from a value produced by the first interpolation filter and a value produced by the second interpolation filter when the first interpolation filter is associated with the fractional pixel position to the immediate left of the referenced fractional pixel position and when the second interpolation filter is associated with the fractional pixel position to the immediate right of the referenced fractional pixel position;
average the horizontal contribution value for the referenced fractional pixel position from a value of a fractional pixel position to the immediate left of the referenced fractional pixel position and a value produced by the first interpolation filter when the first interpolation filter is associated with the fractional pixel position to the immediate right of the referenced fractional pixel position and when the fractional pixel position to the immediate left of the referenced fractional pixel position is vertically collocated with a full pixel position; and
average the horizontal contribution value for the referenced fractional pixel position from a value of a fractional pixel position to the immediate right of the referenced fractional pixel position and a value produced by the second interpolation filter when the second interpolation filter is associated with the fractional pixel position to the immediate left of the referenced fractional pixel position and when the fractional pixel position to the immediate right of the referenced fractional pixel position is vertically collocated with a right-neighboring full pixel position.

49. The computer program product of claim 43, wherein the instructions that cause the processor to select the interpolation filters comprise instructions that cause the processor to select an interpolation filter associated with a fractional pixel position corresponding to the second fractional portion when the second fractional portion can be expressed by a motion vector having the first precision.

50. The computer program product of claim 43, wherein the instructions that cause the processor to select the interpolation filters comprise instructions that cause the processor to select at least one interpolation filter associated with a fractional pixel position that neighbors a fractional pixel position corresponding to the second fractional portion when the second fractional portion cannot be expressed by a motion vector having the first precision but can be expressed by a motion vector having the second precision.

51. The computer program product of claim 43, wherein the instructions that cause the processor to select the interpolation filters comprise instructions that cause the processor to:
identify a referenced fractional pixel position identified by the second fractional portion;
select a first interpolation filter when the first interpolation filter is associated with a fractional pixel position immediately above the referenced fractional pixel position; and
select a second interpolation filter when the second interpolation filter is associated with a fractional pixel position immediately below the referenced fractional pixel position.

52. The computer program product of claim 51, wherein the instructions that cause the processor to interpolate values for the reference block comprise instructions that cause the processor to:
average a vertical contribution value for the referenced fractional pixel position from a value produced by the first interpolation filter and a value produced by the second interpolation filter when the first interpolation filter is associated with the fractional pixel position immediately above the referenced fractional pixel position and when the second interpolation filter is associated with the fractional pixel position immediately below the referenced fractional pixel position;
average the vertical contribution value for the referenced fractional pixel position from a value of a fractional pixel position immediately above the referenced fractional pixel position and a value produced by the first interpolation filter when the first interpolation filter is associated with the fractional pixel position immediately below the referenced fractional pixel position and when the fractional pixel position immediately above the referenced fractional pixel position is horizontally collocated with a full pixel position; and
average the vertical contribution value for the referenced fractional pixel position from a value of a fractional pixel position immediately below the referenced fractional pixel position and a value produced by the second interpolation filter when the second interpolation filter is associated with the fractional pixel position immediately above the referenced fractional pixel position and when the fractional pixel position immediately below the referenced fractional pixel position is horizontally collocated with a below-neighboring full pixel position.

53. The computer program product of claim 43, further comprising instructions that cause the processor to produce the set of interpolation filters from an existing upsampling filter such that each of the interpolation filters is associated with a fractional pixel position that can be referred to by a motion vector having the first precision.

54. The computer program product of claim 43, wherein the instructions that cause the processor to process the chrominance block comprise instructions that cause the processor to:
calculate a residual chrominance value for the chrominance block based on the difference between the chrominance block and the reference block; and
output the residual chrominance value.

55. The computer program product of claim 43, wherein the instructions that cause the processor to process the chrominance block comprise instructions that cause the processor to reconstruct the chrominance block from the reference block and a received residual chrominance value.
